(19) United States
(12) Patent Application Publication
(10) Pub. No.: US 2026/0105471 A1
(43) Pub. Date: Apr. 16, 2026

(54) SYSTEMS AND METHODS FOR RECEIVING HOME RULE DATA TO GENERATE AND PRESENT A PREDICTED HOME MODIFICATION

(71) Applicant: State Farm Mutual Automobile Insurance Company, Bloomington, IL (US)

(72) Inventors: Kami Lavallier, Loudon, TN (US); Emily Bryant, Mesa, AZ (US); Melati Belot, Atlanta, GA (US)

(73) Assignee: State Farm Mutual Automobile Insurance Company, Bloomington, IL (US)

(21) Appl. No.: 19/043,894

(22) Filed: Feb. 3, 2025

Related U.S. Application Data
(60) Provisional application No. 63/707,470, filed on Oct. 15, 2024.

(51) Int. Cl. G06Q 30/0202; G06F 3/16; G06F 40/30; G06Q 50/16

(52) U.S. Cl. CPC G06Q 30/0202; G06F 3/167; G06F 40/30; G06Q 50/16

(57) ABSTRACT

Systems and methods for generating a home modification prediction are disclosed. The method may include, such as by one or more processors: (1) receiving, from a user device, a query comprising home rule data; (2) extracting one or more home rules from the query comprising the home rule data; (3) receiving, from one or more databases, property data associated with a first property; (4) generating one or more home score factors based upon the one or more home rules and the property data; (5) generating a home modification prediction for the first property based upon the one or more home score factors; and/or (6) outputting the home modification prediction to a display of a user device, or otherwise presenting the home modification prediction to a user via a user device, such as a verbal or audible presentation via a voice bot or chatbot.

### CROSS-REFERENCE TO RELATED APPLICATION

This patent application claims the benefit of priority to U.S. Provisional Application No. 63/707,470, filed on Oct. 15, 2024, the entirety of which is incorporated herein by reference.

### TECHNICAL FIELD

This present disclosure relates generally to the field of data processing and predictive analytics. In particular, the present disclosure relates to analyzing and evaluating home certification rule data, generating home score factors based upon the certification rule data and attributes of a property, and generating home modification prediction data based upon the home score factors.

### BACKGROUND

Users have an interest in the sustainability and resiliency of their homes, where information regarding a user's property, the surrounding area, and the availability of important public services may influence a user's decisions regarding the user's property. For example, such information may affect how a user may modify the user's property or influence the features of a new build so that the user's home is sustainable and resilient. However, a user may not be aware of such information that is specific for the user's property. For example, conventional methods may include a user manually analyzing the many certification rules and guidelines that exist to determine which rules and guidelines may apply to the user's property. However, such methods may be error prone, as most homeowners may not know which rules and guidelines apply to the user's specific property.

Additionally, the rules and guidelines may be in a state of being continuously developed to help users adopt practices to optimize the sustainability and resiliency of their homes. These optimization practices may include home modifications that are available in the building phase of a home, home modifications that are available with respect to maintenance, repairs, security measures, and the adoption of devices and services to increase sustainability and resiliency throughout the home. However, users may find it difficult to keep up with the current rules and guidelines, as well as determine how to make the user's home more sustainable.

Additionally, home modification recommendations that are appealing and achievable to one user may not be appealing or achievable to another user. Further, user specific information, such as budgetary constraints and home use considerations, may require an adjustment to the generated home modification recommendations. Conventional methods of generating and providing home modification recommendations to users may often be inefficient and may lack important details that a user would desire to make an informed decision, as well as have other drawbacks. Conventional methods may further include additional ineffectiveness, encumbrances, inefficiencies, and other drawbacks, as well.

### SUMMARY

The present embodiments may relate, inter alia, to data processing and predictive analytics, as discussed above and elsewhere herein. Specifically, the present computer systems and computer-implemented methods may (i) solve technical challenges by analyzing and evaluating home certification rule data; (ii) generate home score factors based upon the certification rule data and property attributes of a property; and/or (iii) generate home modification prediction data based upon the home score factors.

In one aspect, a computer-implemented method for receiving home rule data to generate and display (and/or otherwise present) a predicted home modification may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another and/or each operate as an input and/or output device. In one instance, the computer-implemented method may be performed by one or more local or remote processors of a computing system in communication with one or more local or remote data sources.

The computer-implemented method may include, via one or more local or remote processors, transceivers, sensors, and/or other components: (1) receiving a query comprising home rule data; (2) extracting one or more home rules from the query comprising the home rule data; and/or (3) receiving property data associated with a first property from one or more databases. The property data may include one or more property attributes, the property data including one or more of: location data received from one or more databases; sensor data received from one or more devices located within the first property; or historical data from the one or more databases, wherein the historical data includes past hazard data associated with one or more properties that include at least one of the one or more property attributes of the first property. The computer-implemented method may further include: (4) generating one or more home score factors based upon the one or more home rules and the property data; (5) generating a home modification prediction for the first property based upon the one or more home score factors; and/or (6) outputting the home modification prediction to a display of a user device, or otherwise presenting the home modification prediction to a user via a user device, such as a verbal or audible presentation via a voice bot or chatbot. The method may include additional, less, or alternate functionality, including that discussed elsewhere herein.

In another aspect, a computer system for receiving home rule data to generate and display (and/or otherwise present) a predicted home modification may be provided. The computer system may include one or more local or remote processors of a computing system, and at least one local or remote non-transitory computer readable medium storing instructions. When executed by the one or more processors, the instructions may cause the one or more processors to perform operations that may include: (1) receiving, from a user device, a query comprising home rule data; (2) extracting one or more home rules from the query comprising the home rule data; and/or (3) receiving, from one or more databases, property data associated with a first property. The property data may include one or more property attributes, the property data may include one or more of: location data received from one or more databases; sensor data received from one or more devices located within the first property; or historical data received from the one or more databases, wherein the historical data may include past hazard data associated with one or more properties that may include at least one of the one or more property attributes of the first property. The operations may further include: (4) generating one or more home score factors based upon the one or more home rules and the property data; (5) generating a home modification prediction for the first property based upon the one or more home score factors; and/or (6) outputting the home modification prediction to a display of the user device, or otherwise presenting the home modification prediction to a user via a user device, such as a verbal or audible presentation via a voice bot or chatbot. The computer system may include additional, less, or alternate functionality, including that discussed elsewhere herein.

In still another aspect, a non-transitory computer readable medium may be provided. The non-transitory computer readable medium may store instructions which, when executed by one or more local or remote processors of a computing system, cause the one or more processors to perform operations comprising: (1) receiving, from a user device, a query comprising home rule data; (2) extracting one or more home rules from the query comprising the home rule data; and/or (3) receiving, from one or more databases, property data associated with a first property. The property data may include one or more property attributes, the property data including one or more of: (i) location data received from one or more databases; (ii) sensor data received from one or more devices located within the first property; or (iii) historical data received from the one or more databases, wherein the historical data includes past hazard data associated with one or more properties that include at least one of the one or more property attributes of the first property. The operations may further include: (4) generating one or more home score factors based upon the one or more home rules and the property data; (5) generating a home modification prediction for the first property based upon the one or more home score factors; and/or (6) outputting the home modification prediction to a display of the user device, or otherwise presenting the home modification prediction to a user via a user device, such as a verbal or audible presentation via a voice bot or chatbot. The instructions may direct additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a diagram showing an exemplary architecture diagram for generating home modification prediction data, according to certain aspects of the disclosure.

FIG. 2 is an exemplary flowchart of a computer-implemented or computer-based method for generating home modification prediction data, according to one or more embodiments.

FIG. 3 shows an exemplary machine-learning training flow chart, according to certain aspects of the disclosure.

FIG. 4 illustrates an implementation of an exemplary computer system that executes techniques presented herein.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate, inter alia, to computer systems and computer-implemented methods that may (i) solve technical challenges by analyzing and evaluating home certification rule data; (ii) generate home score factors based upon the certification rule data and property attributes of a property; and/or (iii) generate home modification prediction data based upon the home score factors.

### Exemplary Computing Environment

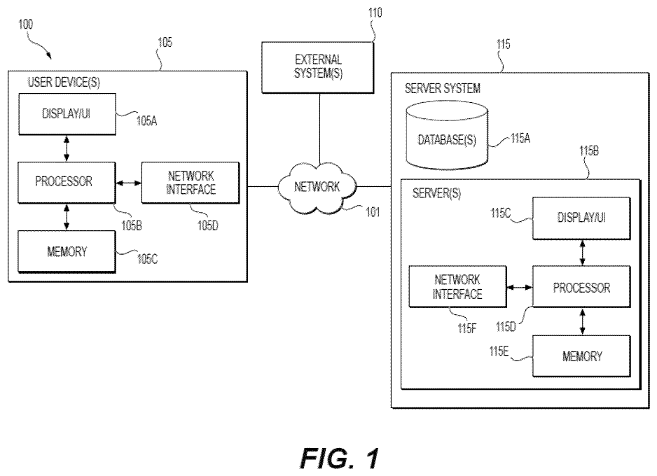

To address technical challenges such as the above, computing system 100 of FIG. 1 improves the state of conventional technologies by implementing advanced data processing and computing capabilities into computer-implemented methods and computer systems for (i) processing real-time and historical data to analyze and evaluate home certification rule data, (ii) generate home score factors based upon the certification rule data and property attributes of a property, and (iii) generate home modification prediction data based upon the home score factors. In one instance, the system 100 may utilize a machine-learning model trained on historical data to learn associations between data, such as patterns and trends, that are indicative of user-adjusted home score factors, and then make accurate predictions based upon the home score factors to determine one or more home modification recommendations.

FIG. 1 depicts an exemplary computing environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more mobile device(s) 105 may be associated with a user, e.g., a user associated with one or more properties, or a user associated with one or more of generating, training, or tuning a machine-learning model for generating user-adjusted home-score factors.

In various embodiments, the components of the computing environment 100 are associated with a common entity. In various embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to generate user-adjusted home score factors, and, more specifically, for adjusting one or more home score factors based upon the one or more home certification rules and the one or more property attributes, the adjustment being based upon received user data to generate one or more user-adjusted home score factors.

The mobile device 105 may be configured to enable the user to access and/or interact with other systems in the environment 100. For example, the mobile device 105 may be a computer system such as, for example, a desktop computer, a mobile device, a tablet, an in-vehicle computer system, infotainment system, etc. In various embodiments, the mobile device 105 may include one or more electronic application(s), e.g., a program, plugin, browser extension, etc., installed on a memory of the mobile device 105.

In certain embodiments, the environment 100 may comprise multiple mobile devices 105. For example, such mobile devices may include a smartphone, tablet, and/or a vehicle computer system.

The mobile device 105 may include a display/user interface (UI) 105A, a processor 105B, a memory 105C, and/or a network interface 105D. The mobile device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, the environment 100 may extend information on a web client that may be accessed through a web browser.

In various embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the operating system. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various output customization tasks. For example, the external systems 110 may comprise computer systems associated with an insurance company, or may comprise systems associated with smart products.

In one instance, server system 115 may include an assessment platform that includes one or more of a data collection module, a data processing module, a policy analysis module, a risk analysis module, a recommendation module, and a user interface module. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the data collection module may collect, e.g., in real-time or near real-time, relevant data from an existing customer filing a claim, a potential customer applying for a new insurance policy or renewing an existing insurance policy, an insurance provider renewing or re-underwriting an existing insurance policy, or a third party (e.g., external data sources) through various data collection techniques. The relevant data may include historical claims data, insurance information, property data, contextual information, etc. The data collection module may include various software applications (e.g., data mining applications in Extended Meta Language (XML)) that automatically search for and return relevant data associated with the users.

For example, the data collection module may use a web-crawling component to access external systems 110 such as smart home devices including a camera, the user device 105, satellite imagery, smart home computer systems and devices, and/or various internal or external data sources to collect relevant data (e.g., data related to a property). In one instance, the relevant data are collected and processed by the system 100 if the user has previously consented to a particular program offered by the insurance provider (e.g., a risk or hazard mitigation program that offers a premium discount or other financial incentive or reward in exchange for underwriting using the images or videos, etc.). In some cases, the relevant data may reside in paper files that are scanned or entered into a digital format by a user or by an automated method (e.g., via a scanner).

The data collection module may transmit the collected data to the data processing module. In one instance, the data processing module may process the images and/or videos of documents or of a property using one or more image analysis techniques (e.g., object recognition, image enhancement, change detection, image classification, image transformation, neural network pattern recognition, matching and classification techniques, etc.) to determine/identify features of the property.

In one instance, the policy analysis module may process information pertaining to the insurance policy of each user (e.g., policyholder) to determine the benefits specified by the policy and/or the terms and conditions of the policy to help determine the home modification recommendations. In one instance, the policy analysis module may process current claims and/or historical claims submitted by the users to dynamically characterize insurance claims and/or dynamically determine causes of loss associated with insurance claims, which may vary geographically. For example, historical claims may include causes of damages to the property (e.g., wind, fire, snow, hail, mold, smoke, etc.) to assess the claims; total costs for paying the claims; incident reports (e.g., police reports); provide functionality that facilitates or helps insureds to schedule service providers for repairing damage to their homes and vehicles; provide functionality that facilitates or helps insureds in filling out and submitting insurance claims and/or collecting relevant data and documents for such, etc.

For instance, current claims may be related to an ongoing claim filed by the users, but may also include raw data retrieved from another computing system of the system 100. In one instance, the policy analysis module may include speech-to-text algorithms for converting human speech into text, for example, audio recordings when a customer calls a customer service center may be converted to text and further utilized by the machine-learning module. The policy analysis module may utilize a natural language processing (NLP) unit for identifying human speech patterns in data, including semantic information relating to entities, such as people, vehicles, homes, and other objects.

In one instance, the policy analysis module may include image analysis algorithms for analyzing images (e.g., extracting information from documents), for example, images of handwritten, typed, or printed notes that are submitted with the claims may be converted to text and further utilized by the machine-learning module. The policy analysis module may perform pattern matching for searching textual claim data for specific strings or keywords in text that may be indicative of particular types of risk. While the examples described herein may refer to analyzing real property insurance claims, it should be appreciated that the techniques described herein may be applicable analyzing claims in other insurance domains, such as agricultural insurance, auto insurance, health or life insurance, renters insurance, personal articles insurance, etc.

The policy analysis module and the machine-learning module may transmit the data relating to the property and the insurance policy, and the historical data (e.g., past claims data, past incident reports, etc.) to the risk or hazard analysis module for further processing. In one instance, the risk or hazard analysis module may analyze the received data and may generate a risk score (e.g., between 0 and 9), wherein a higher risk score(s) may indicate a higher probability for the risk(s) to occur and damage the property.

The risk or hazard analysis module may transmit the risk or hazard score(s) to the recommendation module for further processing. In one instance, the recommendation module may determine whether any risk or hazard-mitigating actions should be taken and/or determine which risk or hazard-mitigating actions to take based upon the risk or hazard score(s).

The recommendation module may generate, via the user interface module, a notification of recommended actions (e.g., tree trimming or roof replacement) in the user device 105 of the user. In another instance, the recommendation module may retrieve a plurality of predetermined home modification plans and determine that a first predetermined home modification plan of the plurality of predetermined home modification plans best corresponds to the one or more user-adjusted home score factors. The recommendation module may generate, via the user interface module, a notification of the recommended home modification plan. In some aspects, the plurality of home modification plans include blueprints for houses to be built to specific certification standards for sustainability and resilience.

Further, external systems 110 may be in communication with other device(s) or system(s) in the environment 100 over the one or more networks 101. For example, external systems 110 may communicate with the server system 115 via API (application programming interface) access over the one or more networks 101, and/or with the mobile device(s) 105 via web browser access over the one or more networks 101. External systems 110 may additionally communicate with one or more other external systems, such as insurance services, regarding relevant data in environment 100.

In various embodiments, the network 101 may be a wide area network (“WAN”), a local area network (“LAN”), a personal area network (“PAN”), or the like. In various embodiments, network 101 includes the Internet, and information and data provided between various systems occurs online.

“Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In various embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third-party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a machine-learning model, configured to generate a customized output based upon baseline data, dynamic data, and/or sensor data. For example, baseline data and account data may be received and stored by server system 115. Baseline data and dynamic data may be described in further detail in the method below. Baseline data and dynamic data may include stored baseline data and dynamic data, as well as previous outputs of the machine-learning model(s). The baseline data, dynamic data, and/or sensor data may be input into the machine-learning model to generate recommendation(s) and/or output(s) regarding adjustment of one or more home score factors used in generating home modification recommendations.

The server system 115 may include a machine-learning model and/or instructions associated with the machine-learning model, e.g., instructions for generating a machine-learning model, training the machine-learning model, using the machine-learning model, etc. The server system 115 may include instructions for customizing outputs based upon baseline data, dynamic data, and/or sensor data, e.g., based upon the output of the machine-learning model, and/or operating the display 115C to output an alert, e.g., as adjusted based upon the machine-learning model. The server system 115 may include training data.

In various embodiments, a system or device other than the server system 115 is used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based upon Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In various embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between user literacy, audio output, and assets (e.g., stocks), such that the trained machine-learning model is configured to determine a user's literacy level and provide audio output based upon the learned associations.

In various embodiments, the variables of a machine-learning model may be interrelated in any suitable arrangement in order to generate the output. For example, the machine-learning model may include one or more convolutional neural network (“CNN”) configured to identify user preferences (e.g., a user literacy level), and may include further architecture, e.g., a connected layer, neural network, etc., configured to determine a relationship between baseline data and/or dynamic data, such as property data and user data.

Further aspects of the machine-learning model and/or how it may be utilized to generate a customized output based upon baseline data, dynamic data, sensor data, and/or other received data may be described in further detail in the method below. In the following method, various acts may be described as performed or executed by a component from FIG. 1, such as the server system 115, the mobile device 105, or components thereof. However, it should be understood that in various embodiments, various components of the environment 100 discussed below may execute instructions or perform acts including the acts discussed below. An act performed by a device may be considered to be performed by a processor, actuator, or the like associated with that device. Further, it should be understood that in various embodiments, various blocks may be added, omitted, and/or rearranged in any suitable manner.

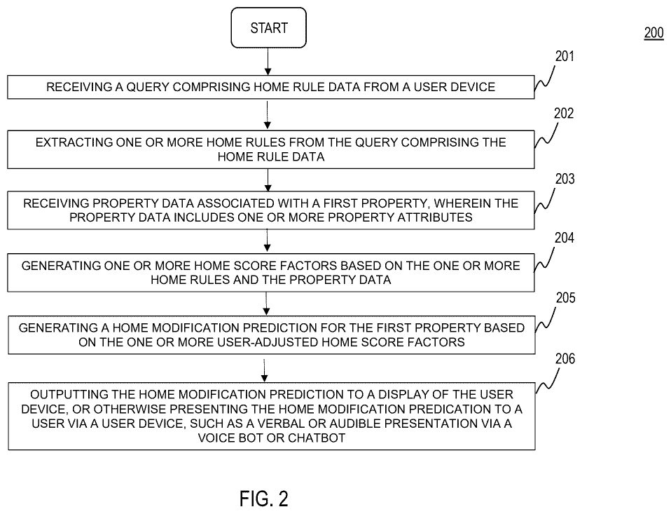

In general, any method or operation discussed in this disclosure that is understood to be computer-implementable, such as the method illustrated in FIG. 2, may be performed by one or more processors of a computer system, such any of the systems or devices in the environment 100 of FIG. 1, as described above. A method or method block performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a method or operation in the examples below, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Although depicted as separate components in FIG. 1, it should be understood that a component or portion of a component in the environment 100 may, in various embodiments, be integrated with or incorporated into one or more other components. For example, a portion of the display 115C may be integrated into the mobile device 105 or the like. In various embodiments, operations or aspects of one or more of the components discussed above may be distributed amongst one or more other components. Any suitable arrangement and/or integration of the various systems and devices of the environment 100 may be used.

### Exemplary Home Modification Recommendation Flowchart

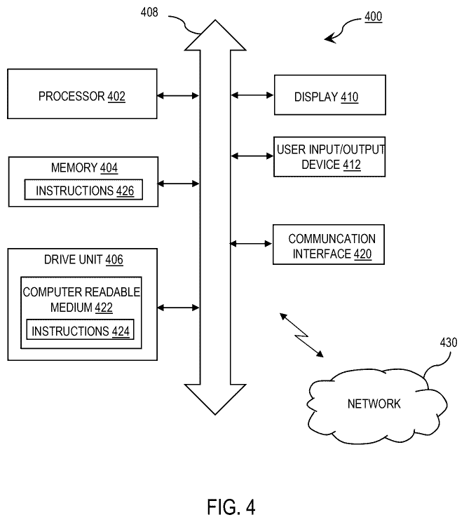

FIG. 2 is an exemplary flowchart of a computer-implemented or computer-based method for generating home modification recommendations. In one instance, the user devices 105, the server system 115, and the external systems 110, alone or in combination, may perform one or more portions of the method 200 and are implemented using, for instance, a chip set including a processor (e.g., processor 402) and a memory (e.g., memory 404) as shown in FIG. 4. As such, the user devices 105, the server system 115, and the external systems 110 may be configured to facilitate accomplishing various parts of the method 200, as well as accomplishing embodiments of other processes described herein in conjunction with other components of the system 100. Although computer-implemented method 200 is illustrated and described as a sequence of actions, operations, and/or functionality, it is contemplated that various embodiments of the method 200 may be performed in any order or combination and need not include all of the illustrated actions, operations, and/or functionality.

In block 201, computer-implemented method 200 may include receiving a query comprising home rule data (e.g., home certification rule data). The query may be received from a user via a user device 105 or received from a third party, such as an insurance provider, via an external system 110 or server system 115. The query may comprise, for example, a checklist of certification rules. The checklist of certification rules may include, in some instances, environmental certification factors, such as environmental hazards and/or benefits, first responder certification factors, construction certification factors, usage certification factors, and/or risk certification factors.

The environmental certification factors may represent the weather, temperature, seasonal hazards and/or changes, local fauna, local flora, air quality, pollen, landscape, bodies of water, and any other such suitable environmental hazards and/or benefits. The environmental certification factors may include location certification factors that may represent location-based hazards and/or benefits. For example, the location certification factors may represent a local population density, a local classification (e.g., urban, rural, suburban, city, town, village, etc.), a proximity to a highway, a proximity to public transportation, a proximity to various businesses, a proximity to neighbors, a proximity to schools, and/or any other such suitable location-based hazards and/or benefits.

The first responder certification factors may represent a first responder's accessibility in emergency events. For example, the first responder certification factors may be representative of the property's proximity to a hospital, proximity to a fire station, proximity to a police station, presence of nearby fire hydrants, ease of ambulance access, and any other such suitable hazards and/or benefits. First responder certification factors may contribute to a safety score associated with the property.

The construction certification factors may represent hazards and/or benefits related to the construction of a house or other item on the property. For example, the construction certification factors may represent an adherence to construction codes, adherence to construction best practices, building materials used, structural stability, architectural design, house age, history of replacements and/or repairs, appliances, smart devices, plumbing, water consumption, power consumption, wiring, security, and any other such suitable hazards and/or benefits. Similarly, usage certification factors may represent hazards and benefits related to the usage of the property, and the occupancy certification factors may represent hazards and benefits related to the occupancy of the property.

In some embodiments, the risk certification factors may represent a level of risk related to the property. The level of risk calculation may include a determination as to past or potential claim damage and/or severity of claim damage. In some embodiments, the level of risk may refer to a level of risk for a particular time period. Additionally or alternatively, the level of risk may include a determination of a quote or cost associated with the level of risk for the particular time period.

In still further embodiments, the level of risk may include a determination of a quote or cost associated with the level of risk for a longer period of time, such as a month, year, etc. In further embodiments, the level of risk may depend on additional factors, such as type of claim, cause of loss, property damage paid out, freeform data (need to understand that from a data perspective, so needs other processing), whether coverage is paid, catastrophe, bodily injury, repair costs, estimated values for items damaged, claim subrogation status, location of loss, date of loss, time of loss, date the claim was reported, etc.

In block 202, computer-implemented method 200 may include extracting one or more home rules (e.g., home certification rules) from the query comprising the home rule data (e.g., home certification rule data). In some instances, the query may include a text document that is not electronically stored. In such instances, extracting the one or more home rules from the query may include applying, by the one or more processors, a natural language processing (NLP) algorithm to the text document to analyze the query and extract text data. Further, the extracting the one or more home rules (e.g., home certification rules) may include determining, by the one or more processors, a semantic meaning or a contextual alignment between the extracted text data and home certification rules stored in one or more reference datasets.

In some examples, applying the NLP algorithm may include extracting, by the one or more processors, certification keywords for the one or more property rules. The NLP algorithm may include image analysis algorithms for analyzing images (e.g., extracting information from documents), for example, images of handwritten, typed, or printed notes that are submitted with the queries may be converted to text and further processed. The system may utilize a pattern matching algorithm for searching textual certification data for specific strings or keywords in text, which may be indicative of particular types of home score factors. The extracted home certification rules may be stored in a data store. While the examples described herein may refer to generating home modification recommendations, it should be appreciated that the techniques described herein may be applicable to other processes, such as analyzing real property insurance claims, analyzing claims in other insurance domains, such as agricultural insurance, auto insurance, health or life insurance, renters insurance, personal articles insurance, etc.

In block 203, computer-implemented method 200 may include receiving property data associated with a first property from a data store and/or a user device. The property data may include one or more property attributes (e.g., location attributes, property attributes). For example, the property data may include location data from one or more databases, where the location data may include one or more location attributes. The property data may further include sensor data from one or more devices located within the first property, where the sensor data may provide one or more property attributes. The sensor data may include telematics data. The property data may include historical data from the one or more databases, such as past hazard data associated with one or more properties that includes at least one of the one or more property attributes of the first property. For example, a second property may be determined as similar to the first property based upon similar location attributes, e.g., in a similar climate, at a similar altitude, with similar proximity to specific hazards, e.g., wildfire risk or flood risk. As a result, past hazards that had befallen the first property, or a home on the first property, may be included in the past hazard data.

In block 204, computer-implemented method 200 may include generating one or more home score factors based upon the one or more home rules and the property data. The home score factors may include one or more of: (i) an environment score; (ii) a location score; (iii) a first responder score; (iv) a construction score; (v) a usage score; (vi) an occupancy score, and/or (v) a risk score.

In some embodiments, the environment score may represent environmental hazards and/or benefits for the property. For example, the environment score may represent the weather, temperature, seasonal hazards and/or changes, local fauna, local flora, air quality, pollen, landscape, bodies of water, and any other such suitable environmental hazards and/or benefits of the property.

The location score may represent location-based hazards and/or benefits. For example, the location score may represent a local population density, a local classification (e.g., urban, rural, suburban, city, town, village, etc.), a proximity to a highway, proximity to public transportation, a proximity to various businesses, a proximity to neighbors, a proximity to schools, and/or any other such suitable location-based hazards and/or benefits of the property.

The first responder score may represent the accessibility of the property to first responders in emergency events. For example, the first responder score may represent the property's proximity to a hospital, proximity to a fire station, proximity to a police station, presence of nearby fire hydrants, ease of ambulance access, and any other such suitable hazards and/or benefits.

The construction score may represent hazards and/or benefits related to the construction of a house or other item on the property. For example, the construction score may represent the adherence to construction codes, adherence to construction best practices, building materials used, structural stability, architectural design, house age, history of replacements and/or repairs, appliances, smart devices, plumbing, water consumption, power consumption, wiring, security, and any other such suitable hazards and/or benefits of the property.

Similarly, the usage score may represent hazards and/or benefits related to the usage of the property, and the occupancy score may represent hazards and benefits related to the occupancy of the property.

In some embodiments, the risk score may represent a level of risk related to the property. The level of risk calculation may include a determination of past or potential claim damage and/or the severity of the claim damage. In some embodiments, the level of risk may refer to a level of risk for a particular time period. Additionally, or alternatively, the level of risk may include a determination of a quote or cost associated with the level of risk for the particular time period. In still further embodiments, the level of risk may include a determination of a quote or cost associated with the level of risk for a longer period of time, such as a month, year, etc. In further embodiments, the level of risk may depend on additional factors, such as a type of claim, a cost of the claim, a cause of loss, a property damage paid out, freeform data, whether coverage is paid, bodily injury, repair or replacement costs, estimated values for items damaged, a claim subrogation status, a location of loss, a date of loss, a time of loss, a date the claim was reported or first notice of loss, etc.

It will be understood that, in some embodiments, some home telematics data and/or user telematics data may influence multiple home score factors as described above. In some such embodiments, the system 100 may only apply the home telematics data and/or user telematics data to the factor most influenced by the data in question. In various embodiments, the system 100 may apply the home telematics data and/or user telematics data to all potential categories. In still other embodiments, the system 100 may apply the home telematics data and/or user telematics data to a first factor and then, based upon the application to the first factor, the system 100 may determine not to apply the home telematics data and/or user telematics data to any other factors.

In some examples, computer-implemented method 200 may include receiving user data associated with a user from the user device. The user data may include one or more of demographic data, financial data, or geolocation data. The user data may include data from the user's mobile device, or other computing devices, such as smart glasses, wearables, smart watches, laptops, etc. The user data may include data associated with the movement of the user, such as GPS or other location data, and/or other sensor data, including camera data or images acquired via the mobile or other computing device. In some embodiments, the user data and/or user telematics data may include historical data related to the user, such as historical home data, historical claim data, historical accident data, etc.

The user data may also include home telematics data collected or otherwise generated by a home telematics app installed and/or running on the user's mobile device or other computing device. For instance, a home telematics app may be in communication with a smart home controller and/or smart appliances or other smart devices situated about a home, and may collect data from the interconnected smart devices and/or smart home sensors. Depending on the embodiment, the user telematics data and/or the home telematics data may include information input by the user at a computing device or at another device associated with the user. In further embodiments, the user telematics data and/or the home telematics data may be collected or otherwise generated after receiving a confirmation from the user, although the user may not directly input the data.

In further embodiments, computer-implemented method 200 may include adjusting one or more of the home score factors based upon the user data to generate one or more user-adjusted home score factors. The user-adjusted home score factors, like the original home score factors described in block 204, may include: (i) an environment score; (ii) a location score; (iii) a first responder score; (iv) a construction score; (v) a usage score; (vi) an occupancy score, and/or (v) a risk score.

The user-adjusted environment score may represent the environmental hazards and/or benefits. For example, the environment score may represent weather, temperature, seasonal hazards and/or changes, local fauna, local flora, air quality, pollen, landscape, bodies of water, and any other such suitable environmental hazards and/or benefits.

The location score may represent location-based hazards and/or benefits. For example, the location score may be representative of local population density, a local classification (e.g., urban, rural, suburban, city, town, village, etc.), a proximity to a highway, a proximity to public transportation, a proximity to various businesses, a proximity to neighbors, a proximity to schools, and/or any other such suitable location-based hazards and/or benefits.

The first responder score may represent the accessibility of the property to first responders in emergency events. For example, the first responder score may represent the proximity to a hospital, proximity to a fire station, proximity to a police station, presence of nearby fire hydrants, ease of ambulance access, and any other such suitable hazards and/or benefits.

The construction score may represent hazards and/or benefits related to the construction of a house or other item on the property. For example, the construction score may represent the adherence to construction codes, adherence to construction best practices, building materials used, structural stability, architectural design, house age, history of replacements and/or repairs, appliances, smart devices, plumbing, water consumption, power consumption, wiring, security, and any other such suitable hazards and/or benefits of the property.

Similarly, the usage score may represent hazards and benefits related to the usage of the property, and the occupancy score may represent hazards and benefits related to the occupancy of the property.

In some embodiments, the risk score may represent a level of risk related to the property. The level of risk calculation may include a determination of past or potential claim damage and/or severity of claim damage. In some embodiments, the level of risk may refer to a level of risk for a particular time period. Additionally or alternatively, the level of risk may include a determination of a quote or cost associated with the level of risk for the particular time period. In still further embodiments, the level of risk may include a determination of a quote or cost associated with the level of risk for a longer period of time, such as a month, year, etc. In further embodiments, the level of risk may depend on additional factors, such as type of claim, a cost of the claim, a cause of loss, a property damage paid out, freeform data, coverage amount, repair or replacement costs, estimated values for items damaged, claim subrogation status, location of loss, date of loss, time of loss, date the claim was reported or first notice of loss, etc.

In block 205, computer-implemented method 200 may include generating a home modification prediction for the first property based upon the one or more user-adjusted home score factors. The user-adjusted home factors, as adjusted based upon the user input, may help determine the home modification recommendation provided to a user. The home modification prediction may include a recommendation based upon the user-adjusted home score factors. The recommendation may include a text recommendation (e.g., whether to purchase a property, modifications to make to a property), an image recommendation (e.g., images of what a future home should look like), and/or a home blueprint.

For example, a user may have the option to build, for example, one of three different homes on a particular property. Each of the three homes may include a different set of home score factors and a different cost associated with building the home. For example, a first home may score the highest on the home score factors and may cost about $1,000,000 to build, a second home may score the next highest on the home score factors and may cost about $500,000 to build, and a third home may score the lowest on the home score factors and may cost about $300,000 to build. Absent any user input, the recommendation may be to build the $1,000,000 home that scores the highest on the home score factors.

However, given the user input information, the user-adjusted scores may be adjusted to reflect that, for example, the user would likely not be able to afford $1,000,000 to build a new home. Or, for example, that the user has no children and prefers a smaller home than the $1,000,000 blueprint. These and other factors may be used to recommend the second home or the third home to the user, even though the homes score lower on the home score factors. A machine-learning model may utilize an adjustment algorithm to perform such an analysis, where the machine-learning model may provide the scalability to analyze a great amount of homes with greater amounts of property attributes, home score factors, and user inputs.

The blueprints may include a plurality of predetermined home modification plans. Generating a home modification prediction for the first property may include retrieving the plurality of predetermined home modification plans from a data store and determining a first predetermined home modification plan of the plurality of predetermined home modification plans that best corresponds to the one or more home score factors, wherein the home modification prediction includes the first predetermined home modification plan. Each of the plurality of predetermined home modification plans may include one or more predetermined home score factors. Additionally, determining the first predetermined home modification plan of the plurality of predetermined home modification plans that best corresponds to the one or more user-adjusted home score factors may include: (i) calculating a similarity score for each of one or more predetermined home score factors for each of the plurality of predetermined home modification plans and a corresponding one of the user-adjusted home score factors; and/or (ii) aggregating the similarity scores for each of the one or more predetermined home score factors for each of the plurality of predetermined home modification plans. The method may further include providing the first predetermined home modification plan as the home modification prediction for the first property.

In block 206, computer-implemented method 200 may include presenting the home modification prediction to user via a user device 105, such as outputting the home modification prediction to a display of a user device, or otherwise visually and/or audibly (or verbally) presenting the home modification to a user via one or more user devices, such as a mobile device equipped with a voice bot or chat bot. Alternatively, or additionally, the home modification prediction may be output to a display/UI 115C of the server system 115 and/or stored in a database 115A of the server system 115. In one instance, the method 200 may include indicating that the users may receive a premium discount or reduced deductible in exchange for implementing the home modification plan. In one instance, the method 200 may include indicating that the insurance discount will increase if the home modification plan is implemented within a stipulated timeframe. In one instance, the method 200 may include subsidizing or otherwise incentivizing any risk or hazard-mitigation services, such as receiving a lower purchase on various services or products, such as specific type of roofing material, windows, fire extinguishers, water sprinkler systems, etc.

### Exemplary Machine-Learning Techniques

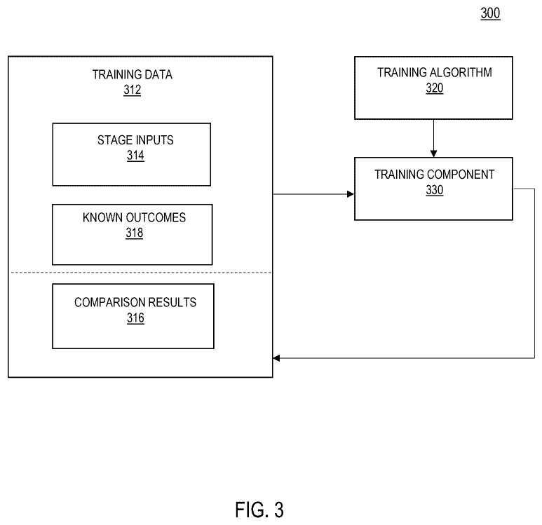

One or more implementations disclosed herein include and/or may be implemented using a machine-learning model. For example, one or more modules described with respect to system 100 in FIG. 1 may be implemented using a machine-learning model and/or may be used to train the machine-learning model. A given machine-learning model may be trained using the data flow 300 of FIG. 3. Training data 312 may include one or more of stage inputs 314 and known outcomes 318 related to the machine-learning model to be trained. The stage inputs 314 may be from any applicable source including text, visual representations, data, values, comparisons, stage outputs, e.g., one or more outputs from one or more actions or operations from FIGS. 1-2. The known outcomes 318 may be included for the machine-learning models generated based upon supervised or semi-supervised training. An unsupervised machine-learning model may not be trained using known outcomes 318. Known outcomes 318 may include known or desired outputs for future inputs similar to or in the same category as stage inputs 314 that do not have corresponding known outputs.

The training data 312 and a training algorithm 320, e.g., one or more of the modules implemented using the machine-learning model and/or may be used to train the machine-learning model, may be provided to a training component 330 that may apply the training data 312 to the training algorithm 320 to generate the machine-learning model. According to an implementation, the training component 330 may be provided comparison results 316 that compare a previous output of the corresponding machine-learning model to apply the previous result to re-train the machine-learning model. The comparison results 316 may be used by training component 330 to update the corresponding machine-learning model. The training algorithm 320 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any method or operation discussed in this disclosure is understood to be computer-implementable, such as the processes illustrated in FIG. 2 may be performed by one or more processors of a computer system as described herein. A method or method action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a method or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### Exemplary Computing System

In general, any method or operation discussed in this disclosure is understood to be computer-implementable, such as the processes illustrated in FIG. 2 and may be performed by one or more processors of a computer system as described herein. A method or method action or operation performed by one or more (local or remote) processors may also be referred to as an operation. The one or more processors may be configured to perform such processes by having access to instructions (e.g., software or computer-readable code) that, when executed by one or more processors, cause the one or more processors to perform the processes. The instructions may be stored in a (local or remote) memory of the computer system. A processor may be a central processing unit (CPU), a graphics processing unit (GPU), or any suitable type of processing unit.

A computer system, such as a system or device implementing a method or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 4 illustrates an implementation of a computer system that may execute techniques presented herein. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 400 may be implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 may include a cache or random-access memory for the processor 402. In alternative implementations, the memory 404 is separate from the processor 402, such as a cache memory of a processor, the system memory, or other memory.

The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions 426 executable by the processor 402. The functions, acts or tasks illustrated in the figures or described herein may be performed by the processor 402 executing the instructions stored in the memory 404. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406 implemented as a disk or optical drive. The drive unit 406 may include a computer-readable medium 422 in which one or more sets of instructions 424, e.g., software, can be embedded. Further, instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, computer-readable medium 422 includes the set of instructions 424 or receives and executes the set of instructions 424 responsive to a propagated signal so that a device connected to network 430 can communicate voice, video, audio, images, or any other data over the network 430. Further, the set of instructions 424 may be transmitted or received over the network 430 via communication port or interface 420, and/or using bus 408. The communication port or interface 420 may be a part of the processor 402 or may be a separate component. The communication port or interface 420 may be created in software or may be a physical connection in hardware.

The communication port or interface 420 may be configured to connect with a network 430, external media, the display 410, or any other components in computer system 400, or combinations thereof. The connection with the network 430 may be a physical connection, such as a wired Ethernet connection or may be established wirelessly as discussed below. Likewise, the additional connections with other components of the computer system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 400 may be connected to network 430. The network 430 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols.

The network 430 may include wide area networks (WAN), such as the Internet, local area networks (LAN), campus area networks, metropolitan area networks, a direct connection such as through a Universal Serial Bus (USB) port, or any other networks that may allow for data communication.

The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices.

The network 430 may be divided into sub-networks. The sub-networks may allow access to all of the other components connected thereto or the sub-networks may restrict access between the components. The network 430 may be a public or private network connection and may include, for example, a virtual private network or an encryption or other security mechanism employed over the public Internet, or the like.

### Exemplary Embodiments

A computer-implemented method for receiving home rule data to generate and display a predicted home modification may be provided. The computer-implemented method may be performed by one or more local or remote processors of a computing system in communication with one or more local or remote data sources. The computer-implemented method may include (1) receiving a query comprising home rule data; (2) extracting one or more home rules from the query comprising the home rule data; (3) receiving property data associated with a first property. The property data may include one or more property attributes, the property data including one or more of: location data received from one or more databases; sensor data received from one or more devices located within the first property; or historical data received from the one or more databases, wherein the historical data includes past hazard data associated with one or more properties that include at least one of the one or more property attributes of the first property. The computer-implemented method may further include (4) generating one or more home score factors based upon the one or more home rules and the property data; (5) generating a home modification prediction for the first property based upon the one or more home score factors; and (6) outputting the home modification prediction to a display of a user device, or otherwise presenting the home modification prediction to a user via a user device, such as a verbal or audible presentation via a voice bot or chatbot. The method may include additional, less, or alternate functionality, including that discussed elsewhere herein.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

For instance, extracting the one or more home rules from the query comprising the home rule data may comprise: applying a natural language processing (NLP) algorithm to analyze the query and extract text data; and (ii) determining a semantic meaning or a contextual alignment between the extracted text data and home rules stored in one or more reference datasets. Applying the NLP algorithm may include analyzing the text data to determine one or more patterns corresponding to the one or more home rules.

In certain aspects, generating a home modification prediction for the first property may include determining a first predetermined home modification plan of the plurality of predetermined home modification plans that best corresponds to the one or more home score factors, wherein the home modification prediction includes the first predetermined home modification plan.

In certain embodiments, each of the plurality of predetermined home modification plans comprises one or more predetermined home score factors. Generating a home modification prediction for the first property further comprises calculating a similarity score for each of one or more predetermined home score factors and each of the plurality of predetermined home modification plans, and selecting, by the one or more processors, the predetermined home modification plan with the highest similarity score

Additionally or alternatively, the computer-implemented method may include: receiving user data from a user device, generating one or more user-adjusted home score factors based upon the user data, and modifying, via a trained machine-learning model, one or more of the one or more home score factors based upon the one or more user-adjusted home score factors.

In still other embodiments, the one or more property attributes include one or more of a location attribute, a climate attribute, a power consumption attribute, or a water consumption attribute. Additionally, the one or more home score factors include one or more of: a fire hazard score, a safety score, a weather hazard score, a property feature hazard score, or a resiliency score.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments where multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may access the memory device later to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for receiving home rule data to generate and display a predicted home modification, the computer-implemented method comprising:
receiving, by one or more processors, a query comprising home rule data from a user device;
extracting, by the one or more processors, one or more home rules from the query comprising the home rule data;
receiving, by the one or more processors, property data associated with a first property from one or more databases, wherein the property data includes one or more property attributes, the property data including one or more of:
location data received from one or more databases;
sensor data received from one or more devices located within the first property; or
historical data received from the one or more databases, wherein the historical data includes past hazard data associated with one or more properties that include at least one of the one or more property attributes of the first property;
generating, by the one or more processors, one or more home score factors based upon the one or more home rules and the property data;
generating, by the one or more processors, a home modification prediction for the first property based upon the one or more home score factors; and
outputting the home modification prediction to a display of a user device, or otherwise presenting the home modification prediction to a user via a user device, such as a verbal or audible presentation via a voice bot or chatbot.

2. The computer-implemented method of claim 1, wherein extracting, by the one or more processors, the one or more home rules from the query comprising the home rule data comprises:
applying, by the one or more processors, a natural language processing (NLP) algorithm to the query to extract text data; and
determining, by the one or more processors, a semantic meaning or a contextual alignment between the text data and the one or more home rules stored in one or more reference datasets.

3. The computer-implemented method of claim 2, wherein applying the NLP algorithm includes:
analyzing, by the one or more processors, the text data to determine one or more patterns corresponding to the one or more home rules.

4. The computer-implemented method of claim 1, the computer-implemented method further comprising:
retrieving, by the one or more processors, a plurality of predetermined home modification plans from a data store.

5. The computer-implemented method of claim 4, wherein generating a home modification prediction for the first property comprises:
determining, by the one or more processors, a first predetermined home modification plan of the plurality of predetermined home modification plans that best corresponds to the one or more home score factors, wherein the home modification prediction includes the first predetermined home modification plan.

6. The computer-implemented method of claim 4, wherein each of the plurality of predetermined home modification plans comprises one or more predetermined home score factors.

7. The computer-implemented method of claim 6, wherein generating a home modification prediction for the first property further comprises:
calculating, by the one or more processors, a similarity score for each of one or more predetermined home score factors and each of the plurality of predetermined home modification plans; and
selecting, by the one or more processors, the predetermined home modification plan with the highest similarity score.

8. The computer-implemented method of claim 1, the computer-implemented method further comprising:
receiving, by the one or more processors, user data from a user device;
generating, by the one or more processors, one or more user-adjusted home score factors based upon the user data; and
modifying, by the one or more processors, via a trained machine-learning model, one or more of the one or more home score factors based upon the one or more user-adjusted home score factors.

9. The computer-implemented method of claim 1, wherein the one or more property attributes include one or more of: a location attribute, a climate attribute, a power consumption attribute, or a water consumption attribute.

10. The computer-implemented method of claim 1, wherein the one or more home score factors include one or more of: a fire hazard score, a safety score, a weather hazard score, a property feature hazard score, or a resiliency score.

11. A system comprising:
one or more processors of a computing system; and
at least one non-transitory computer readable medium storing instructions which, when executed by the one or more processors, cause the one or more processors to perform operations comprising:
receiving, from a user device, a query comprising home rule data;
extracting one or more home rules from the query comprising the home rule data;
receiving, from one or more databases, property data associated with a first property, wherein the property data includes one or more property attributes, the property data including one or more of:
location data received from one or more databases;
sensor data received from one or more devices located within the first property; or
historical data received from the one or more databases, wherein the historical data includes past hazard data associated with one or more properties that include at least one of the one or more property attributes of the first property;
generating one or more home score factors based upon the one or more home rules and the property data;
generating a home modification prediction for the first property based upon the one or more home score factors; and
outputting the home modification prediction to a display of a user device, or otherwise presenting the home modification prediction to a user via a user device, such as a verbal or audible presentation via a voice bot or chatbot.

12. The system of claim 11, wherein extracting the one or more home rules from the query comprising the home rule data comprises:
applying a natural language processing (NLP) algorithm to the query and to extract text data; and
determining a semantic meaning or a contextual alignment between the text data and the one or more home rules stored in one or more reference datasets.

13. The system of claim 12, wherein applying the NLP algorithm includes:
analyzing the text data to determine one or more patterns corresponding to the one or more home rules.

14. The system of claim 11, the operations further comprising:
retrieving a plurality of predetermined home modification plans from a data store.

15. The system of claim 11, the operations further comprising:
determining a first predetermined home modification plan of the plurality of predetermined home modification plans that best corresponds to the one or more home score factors, wherein the home modification prediction includes the first predetermined home modification plan.

16. The system of claim 15, wherein each of the plurality of predetermined home modification plans comprises one or more predetermined home score factors.

17. The system of claim 16, wherein generating a home modification prediction for the first property further comprises:
calculating, by the one or more processors, a similarity score for each of one or more predetermined home score factors and each of the plurality of predetermined home modification plans; and
selecting, by the one or more processors, the predetermined home modification plan with the highest similarity score.

18. A non-transitory computer readable medium, the non-transitory computer readable medium storing instructions which, when executed by one or more processors of a computing system, cause the one or more processors to perform operations comprising:
receiving a query comprising home rule data from a user device;
extracting one or more home rules from the query comprising the home rule data;
receiving property data associated with a first property, wherein the property data includes one or more property attributes, the property data including one or more of:
location data received from one or more databases;
sensor data received from one or more devices located within the first property; or
historical data received from the one or more databases, wherein the historical data includes past hazard data associated with one or more properties that include at least one of the one or more property attributes of the first property;
generating one or more home score factors based upon the one or more home rules and the property data;
generating a home modification prediction for the first property based upon the one or more home score factors; and
outputting the home modification prediction to a display of a user device, or otherwise presenting the home modification prediction to a user via a user device, such as a verbal or audible presentation via a voice bot or chatbot.

19. The non-transitory computer readable medium of claim 18, wherein extracting the one or more home rules from the query comprising the home rule data comprises:
applying a natural language processing (NLP) algorithm to the query to extract text data; and
determining a semantic meaning or a contextual alignment between the extracted text data and the one or more home rules stored in one or more reference datasets.

20. The non-transitory computer readable medium of claim 19, further comprising:
analyzing the text data to determine one or more patterns corresponding to the one or more home rules.
